(19) United States
(12) Patent Application Publication
(10) Pub. No.: US 2006/0264212 A1
(43) Pub. Date: Nov. 23, 2006

(54) Method and system for a roam-less mobile unit

(76) Inventor: Ramesh Sekhar, San Jose, CA (US)

Correspondence Address: FAY KAPLUN & MARCIN, LLP, 15O BROADWAY, SUITE 702, NEW YORK, NY, 10038, US

(21) Appl. No.: 11/133,784

(22) Filed: May 20, 2005

(51) Int. Cl. H04Q 7/20

(52) U.S. Cl. 455/432.1; 455/432.2

(57) ABSTRACT

Described is system and method for assigning a unique identifier to a mobile unit (MU) requesting to be associated with a wireless network, transmitting the unique identifier to the MU, monitoring a location of the MU within a coverage area of the wireless network and selecting one of a plurality of access points to broadcast a beacon based on the unique identifier, wherein the MU communicates with the one access point.

### BACKGROUND INFORMATION

Wireless networks may include a variety of different devices, but regardless of the number and type of devices in the network, the purpose of a wireless network is to allow users of mobile devices to move freely from location to location and maintain contact with the network. The idea of moving a mobile device to different locations and associating with different network devices to maintain contact with the network is generally referred to as roaming within the network.

A typical wireless network will include a series of base stations (e.g., access points) whose coverage area defines the boundaries of the wireless network. As mobile devices move from the coverage area of one base station into the coverage area of another base station, the mobile device needs to associate with the new base station. Creating the new association includes the accomplishment of a variety of tasks such as a re-authentication of the mobile device with the new base station. This process of re-associating with a new base station each time the mobile device roams into a new coverage area costs time and dedicates processing power to tasks which are unrelated to the tasks which the user is trying to complete with the mobile device. In addition, if there is a current data packet transfer occurring when the re-association is taking place, it is also possible to lose packets in the process.

### SUMMARY OF THE INVENTION

A method for assigning a unique identifier to a mobile unit (MU) requesting to be associated with a wireless network, transmitting the unique identifier to the MU, monitoring a location of the MU within a coverage area of the wireless network and selecting one of a plurality of access points to broadcast a beacon based on the unique identifier, wherein the MU communicates with the one access point.

A system including a mobile unit (MU), a plurality of access points, each access point including a coverage area and a wireless switch of a wireless network receiving a request from the MU to associate with the wireless network, the wireless switch assigning a unique identifier to the MU and transmitting the unique identifier to the MU, the wireless switch further selecting one of the access points to broadcast a beacon based on the unique identifier, wherein the selecting of the one access point is based on a monitored location of the MU and at least one statistic of the wireless network.

A wireless switch connected to a wireless network, the wireless switch configured to assign a unique identifier to a mobile unit (MU) requesting to be associated with the wireless network, transmit the unique identifier to the MU, monitor a location of the MU within a coverage area of the wireless network and select one of a plurality of access points to broadcast a beacon based on the unique identifier, wherein the MU communicates with the one access point.

### BRIEF DESCRIPTION OF THE DRAWINGS

FIG. 1 shows an exemplary wireless network on which the exemplary embodiment of the present invention may be implemented.

FIG. 2 shows an exemplary process for implementing a roam-less MU according to the present invention.

### DETAILED DESCRIPTION

The present invention may be further understood with reference to the following description and the appended drawings, wherein like elements are provided with the same reference numerals. The present invention discloses a system and method for implementing a roam-less mobile unit (MU) within a wireless network. More specifically, the association of an MU with a network communication device is not controlled by the MU, but by a network device which understands the condition of the entire (or at least a segment) of the wireless network. The exemplary embodiments will be described with reference to an IEEE 802.11 wireless network. However, those of skill in the art will understand that the present invention may also be utilized with other types of network protocols and architectures. This description will provide a description of the functionality to be provided in the MUs and network infrastructure to implement the present invention for any type of wireless network.

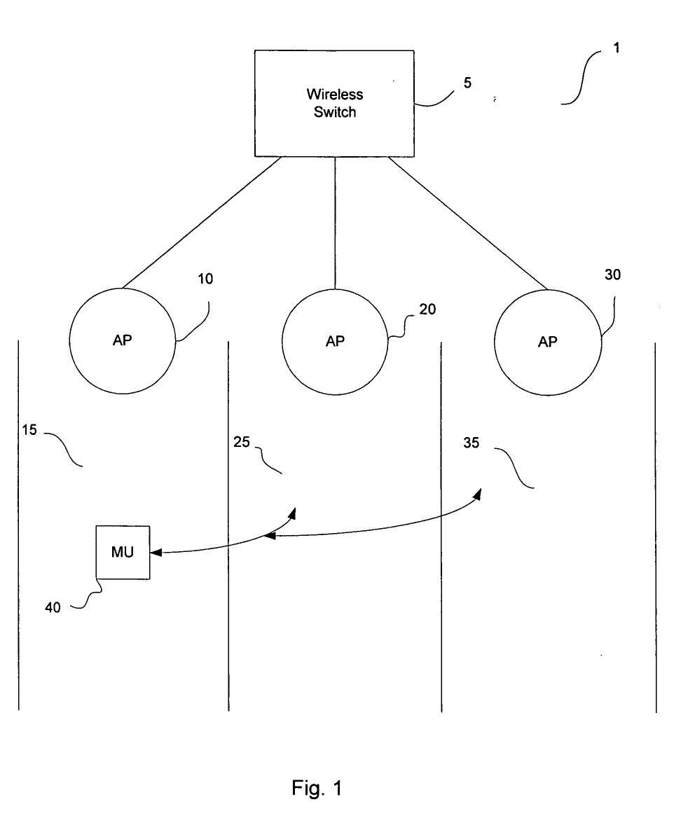

FIG. 1 shows an exemplary wireless network 1 on which the exemplary embodiment of the present invention may be implemented. The wireless network 1 includes a wireless switch 5 that is connected (wired or wirelessly) to access points (“AP”) 10, 20 and 30. Each of the APs 10, 20 and 30 have a corresponding coverage area 15, 25 and 35, respectively. A mobile unit (“MU”) 40 is shown as being initially in the coverage area 15 of the AP 10. The lines and arrows coming from the MU 40 indicate that the MU 40 may move between the various coverage areas 15, 25 and 35 of the APs 10, 20 and 30.

When the MU 40 is in coverage area 15 of AP 10, the MU 40 and the AP 10 communicate wirelessly to exchange data in both directions, i.e., from the AP 10 to the MU 40 for data destined for the MU 40 and from the MU 40 to the AP 10 for data destined for the network 1. However, before any data is exchanged, the MU 40 must associate with the AP 10.

In a standard IEEE 802.11 network, each AP broadcasts a beacon at regular intervals to advertise its presence to MUs that can hear the broadcast. The beacon header contains a source address that identifies the area of coverage for this AP called the Basic Service Set (“BSS”) identification. Each AP may advertise one or more BSSs by sending out a unique beacon for each BSS. Each beacon also contains a wireless LAN identifier called the Extended Service Set (“ESS”) identification and some encryption-related information about the ESS. Typically, an ESS has a unique VLAN assigned to it on the wired side of the network and a unique encryption policy assigned to it. Thus, an AP advertises one or more BSSs and each BSS supports at least one ESS. In order for an MU to connect to a certain VLAN on the wired network, it must successfully associate to the corresponding ESS at the BSS that carries the ESS. The AP grants or denies the association.

However, the exemplary embodiment of the present invention allows for a unique BSS to be assigned to each MU, e.g., the MU 40 is assigned a unique BSS. In this arrangement, as the MU 40 moves through the different coverage areas 15, 25 and 35, the unique BSS for the MU 40 is moved dynamically to the corresponding AP 10, 20 and 30. Thus, after the initial association of the MU 40 with its unique BSS, there is no need to re-associate with a new AP when entering a new coverage area, eliminating the disadvantages associated with re-association. Since the MU 40 does not have to re-associate after the initial association, it may be considered that the MU 40 does not have to roam from AP-to-AP, e.g., it is a roam-less MU.

The exemplary embodiment of the present invention essentially eliminates the concept of roaming within a wireless network because the MU is not aware that it is moving from a first coverage area to a second coverage area. Furthermore, assigning a unique BSS to an MU avoids problems associated with supporting multiple ESSs on a single BSS.

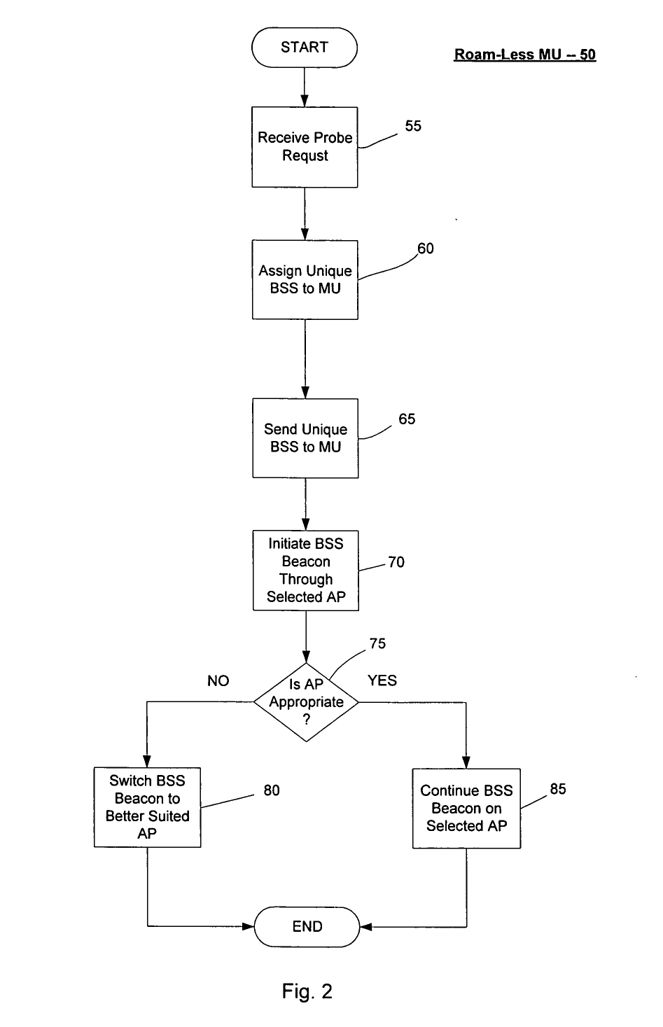

FIG. 2 shows an exemplary process 50 for implementing a roam-less MU. The process 50 of FIG. 2 will be described with reference to the exemplary network 1 of FIG. 1. When the MU 40 first enters the network 1, the MU 40 must become associated with the network 1. To accomplish this, the MU 40 will send a probe message to the network 1 via the nearest AP. The probe message indicates that the MU 40 desires to become associated with the network 1. In the example of FIG. 1, the probe message will be sent though the AP 10 since the MU 40 is initially in the coverage area 15 of the AP 10.

Those of skill in the art will understand that the probe message may include various information for the purposes of associating with the network such as identification and authentication information. Each type of network may require different types of information. However, the type of information in the probe message for different types of networks is not important for the exemplary embodiment of the present invention.

The probe message will be transmitted by the AP (e.g., the AP 10) to the wireless switch 5 (step 55). In step 60, the wireless switch 5 assigns a unique BSS for the MU 40 which sent the probe message. The wireless switch 5 may include a pool of unique BSSs which could be assigned to the MU 40. In addition, when the MU 40 is no longer on the network 1, the unique BSS that was assigned to the MU 40 may be re-captured in the pool of available unique BSSs for use with another MU.

In step 65, the wireless switch 5 sends a probe response to the MU 40 indicating the assigned unique BSS. The wireless switch 5 sends the probe response through an AP which the wireless switch deems the most appropriate for the MU 40 and the network 1. As will be described in greater detail below, an advantage of the exemplary embodiment of the present invention is that the wireless switch 5 which has an overall picture of the entire network 1 is able to associate the MU 40 with the AP that is most appropriate. Again, in this example, the wireless switch 5 may select the AP 10 because the MU 40 is in the coverage area 15.

After the completion of step 65, the MU 40 is associated with the network 1. In step 70, the wireless switch 5 initiates beacons for the new BSS through the selected AP (e.g., the AP 10). The wireless switch 5 continues to track the MU 40 through the network 1 in order to determine if a different AP should be sending the beacon for the BSS.

Thus, in step 75, the wireless switch 5 continues to evaluate if the beacon is being sent by the correct AP. For example, if it is considered that the MU 40 has moved from the coverage area 15 of AP 10 to the coverage area 25 of the AP 20, the wireless switch 5 in tracking the MU 40 will realize that the AP 20 is the more appropriate AP to send the beacon. Therefore, in step 80, the wireless switch 5 will switch the BSS beacon for the MU 40 from the AP 10 to the AP 20. If the AP 10 remains the appropriate AP, the process continues to step 85 where the BSS beacon continues to be broadcast by the AP 10.

The process 50 of FIG. 2 is then shown as ending. However, those of skill in the art will understand that the wireless switch 5 will continue to track the MU 40 as it moves to different locations and move the BSS beacon to different APs as is appropriate. Thus, the steps 75-85 are continuous as long as the MU 40 remains on the network 1.

As can be seen from the above process 50, the MU 40 does not need to roam as it moves from a first coverage area to a second coverage area. For example, as the MU 40 moves from the coverage area 15 of the AP 10 to the coverage area 25 of the AP 20, the wireless switch 5 will cause the unique BSS beacon for the MU 40 to move from the AP 10 to the AP 20. The move from the AP 10 to the AP 20 will be transparent to the MU 40, i.e., the MU 40 will not have to re-associate with the new AP 20 because it continues to hear its unique BSS beacon.

Furthermore, the process 50 shows that the wireless switch 5 is the device which controls the roam for the MU 40. As described above, the wireless switch 5 is aware of the condition of the entire network 1. Therefore, the decisions of the wireless switch 5 (e.g., determining which AP should send the BSS beacon for a particular MU) can be made considering the condition of the entire network, thereby making the network operate more efficiently. Those of skill in the art will understand that the wireless switch 5 may include network statistics that detail the overall condition of the network and different segments of the network.

The following provides an example of the wireless switch 5 making a better decision with respect to the network 1 than the MU 40. In this example, it may be considered that the MU is located in a location where the coverage areas 15 and 25 of APs 10 and 20, respectively, overlap (not shown on FIG. 1). If the MU 40 was making the decision as to which AP it should be associated, the MU 40 may make the decision based on, for example, the relative signal strength of the signals received from the APs 10 and 20. However, the wireless switch 5 understanding the condition of the entire network 1 may select the AP having the lower strength signal. For example, if the AP 10 has a stronger signal the MU 40 would select the AP 10 for association. However, for load balancing reasons, the wireless switch 5 may understand that the network 1 is better with the MU 40 associating with the AP 20. Thus, the wireless switch 5 will instruct the unique BSS beacon to be broadcast by the AP 20, instead of the AP 10 which would have been selected by the MU 40.

Another solution which could be implemented is for all the APs to broadcast the unique BSS beacon. However, this is not very scalable because in a real world wireless network there may be tens or hundreds of MUs on the network and to have each AP transmit every possible unique BSS beacon would eliminate the benefits of eliminating the re-association of roaming. In addition, the overlapping beacons may cause problems for the MUs. The exemplary implementation described with reference to process 50 of FIG. 2, eliminates these problems because the unique BSS beacon for the MU is only sent out in the vicinity of the MU.

Moreover, as implemented in the exemplary embodiment, the MU does not require any proprietary software. That is, the MU is communicating in the same manner it normally communicates. It looks for the BSS beacon that it wants and transmits to that AP. However, in this case, the MU is always looking for the unique BSS beacon assigned to the MU.

The above exemplary embodiment was described with reference to a network 1 which included a wireless switch 5 and where the MU 40 was identified using a unique BSS. However, those of skill in the art will understand that the present invention may be implemented on other network architectures. In other types of network architectures, the MUs could be uniquely identified in other manners. Moreover, other hardware devices than a wireless switch (e.g., a network server or control device) may be used to assign the unique identifiers to the MUs and track the MUs through the network.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
assigning a unique identifier to a mobile unit (MU) requesting to be associated with a wireless network;
transmitting the unique identifier to the MU;
monitoring a location of the MU within a coverage area of the wireless network; and
selecting one of a plurality of access points to broadcast a beacon based on the unique identifier, wherein the MU communicates with the one access point.

2. The method of claim 1, wherein the selecting of the one access point is based on the monitored location of the MU and at least one statistic of the wireless network.

3. The method of claim 1, further comprising the step of:
selecting another one of the plurality of access points to broadcast the beacon when the monitored location of the MU has changed, wherein, when the another access point is selected, the one access point ceases to broadcast the beacon and the MU communicates with the another access point.

4. The method of claim 1, further comprising the step of:
receiving a probe request from the MU requesting association with the wireless network;

5. The method of claim 4, further comprising the step of:
formatting a probe response including the unique identifier, wherein the transmitting of the unique identifier to the MU includes transmission of the probe response.

6. The method of claim 1, wherein the unique identifier is a BSS.

7. The method of claim 1, wherein the wireless network is an IEEE 802.11 network.

8. A system, comprising:
a mobile unit (MU);
a plurality of access points, each access point including a coverage area; and
a wireless switch of a wireless network receiving a request from the MU to associate with the wireless network, the wireless switch assigning a unique identifier to the MU and transmitting the unique identifier to the MU, the wireless switch further selecting one of the access points to broadcast a beacon based on the unique identifier, wherein the selecting of the one access point is based on a monitored location of the MU and at least one statistic of the wireless network.

9. The system of claim 8, wherein the MU communicates with the one access point broadcasting the beacon.

10. The system of claim 8, wherein the wireless switch selects another one of the plurality of access points to broadcast the beacon when the monitored location of the MU has changed.

11. The system of claim 8, wherein the unique identifier is a BSS.

12. A wireless switch connected to a wireless network, the wireless switch configured to:
assign a unique identifier to a mobile unit (MU) requesting to be associated with the wireless network;
transmit the unique identifier to the MU;
monitor a location of the MU within a coverage area of the wireless network; and
select one of a plurality of access points to broadcast a beacon based on the unique identifier, wherein the MU communicates with the one access point.

13. The wireless switch of claim 12, wherein the selecting of the one access point is based on the monitored location of the MU and at least one statistic of the wireless network.

14. The wireless switch of claim 12, wherein the wireless switch is further configured to:
select another one of the plurality of access points to broadcast the beacon when the monitored location of the MU has changed, wherein, when the another access point is selected, the one access point ceases to broadcast the beacon and the MU communicates with the another access point.

15. The wireless switch of claim 12, wherein the wireless switch is further configured to:
receive a probe request from the MU requesting association with the wireless network;

16. The wireless switch of claim 15, wherein the wireless switch is further configured to:
format a probe response including the unique identifier, wherein the transmitting of the unique identifier to the MU includes transmission of the probe response.

17. The wireless switch of claim 12, wherein the unique identifier is a BSS.

18. The wireless switch of claim 12, wherein the wireless network is an IEEE 802.11 network.
